(19) United States
(12) Patent Application Publication
(10) Pub. No.: US 2008/0100918 A1
(43) Pub. Date: May 1, 2008

(54) LARGE FORMAT LENTICULAR COMPOSITE

(76) Inventor: Thomas K. Saville, Jr., Fresno, CA (US)

Correspondence Address: LUEDEKA, NEELY & GRAHAM, P.C., P O BOX 1871, KNOXVILLE, TN, 37901, US

(21) Appl. No.: 11/554,250

(22) Filed: Oct. 30, 2006

(51) Int. Cl. G02B 27/10

(52) U.S. Cl. 359/619

(57) ABSTRACT

A large format lenticular composite, includes a lenticular lens sheet having a thickness of about 0.04 inches (40 mils) and a lens focal length greater than about 0.04 inches (40 mils); a substantially transparent solid spacer adjacent the lens sheet; and an image located adjacent the spacer opposite the lens sheet so as to be spaced a distance from the lens sheet substantially corresponding to the lens focal length.

### FIELD

This disclosure relates to the field of lenticular structures. More particularly, this disclosure relates to large format lenticular structures.

### BACKGROUND

The market for large-format lenticular structures has been growing steadily. The use of large-format displays is desired for tradeshow and outdoor advertisements. For example, large format displays having multi-dimensional visual effects have been observed to gather considerable attention from viewers. The term “large-format” will be understood to refer to lenticular structures having a focal length of about 0.04 inches (40 mils) or more, such as 0.25 inches (250 mils) or greater.

The large format lenticular structures are usually used to provide displays having length and width dimensions of at least about 30 inches by about 40 inches or greater. For super-large lenticular displays, the display may be tiled or segmented using a plurality of the large-format structures that are butted together to provide a single image to the viewer. The large focal lengths utilized with such displays provides desirable image characteristics, e.g., three-dimensional or motion effects, to viewers of the large displays. Such desirable image characteristics are diminished when lesser focal lengths are utilized in providing the lenticular image.

Large format lenticular structures are conventionally made by extruding a lenticular sheet having a thickness approximately equal to the focal length and then printing an image directly onto the smooth side of the lenticular sheet (opposite the side having a lenticular pattern), or printing the image onto a second surface (such as photographic paper) and adhering the second surface onto the smooth surface of the lenticular sheet.

For example, a lenticular sheet having a twenty lenticles per inch (20 lpi) and a narrow viewing angle may have a focal length of 0.25 inches. In this instance, desirable viewing effects may be achieved by locating the printed image 0.25 inches behind the surface of the lenticles. This is conventionally accomplished by providing the lenticular sheet in a thickness of 0.25 inches. However, it has been observed that quality control issues result in difficulties in the manufacture of lenticular sheets of suitable quality having a thickness greater than about 0.04 inches (40 mils).

For example, when making lenticular sheets thicker than about 40 mils, the plastic used to make the lenticular sheets tends to contract as it cools and thereby warp or distort the lenticular pattern. Also, cutting the extruded sheets to the desired lengths can cause a distortion similar to a boat wake as the cutting process pushes through the hardening plastic. Such problems typically are not prevalent in the manufacture of lenticular sheets thinner than 40 mils which are commonly used for postcards, credit cards, and the like. However, such thin lenticular sheets are not used in the manufacture of large size lenticular displays because their thicknesses do not provide the desired focal lengths utilizing conventional manufacturing techniques. Also, the thickness of the thick lenticular sheets conventionally used in the manufacture of large format displays provides durability desirable to enable outdoor advertisements and the like to withstand weather and temperature extremes. These advantages are lost when a thin lenticular sheet made with conventional manufacturing techniques is used.

The present disclosure advantageously utilizes thin lenticular sheets in the manufacture of large format lenticular displays, thus overcoming the disadvantages associated with conventionally manufactured large format lenticular structures, while still retaining the advantages associated with thick lenticular sheets in regard to durability and resistance to weather and temperature extremes.

Utilizing manufacturing techniques according to the disclosure, lenticular structures may be achieved which provide a focal length substantially greater than the thickness of the lenticular sheet to provide desired viewing characteristics while avoiding the disadvantages associated with conventional techniques in which the focal length is dependent upon the thickness of the lenticular sheet.

### SUMMARY

The above and other needs are met by large format lenticular structures and associated manufacturing processes in accordance with the disclosure.

In one aspect, large format lenticular structures include a lenticular lens sheet having a thickness of about 0.04 inches (40 mils) and a lens focal length greater than about 0.04 inches (40 mils); a substantially transparent solid spacer adjacent the lens sheet, and an image located adjacent the spacer opposite the lens sheet so as to be spaced a distance from the lens sheet substantially corresponding to the lens focal length.

In another aspect, the disclosure provides a method of making large format lenticular structures. The method includes the steps of providing a lenticular lens sheet having a thickness of about 0.04 inches (40 mils) and a lens focal length greater than about 0.04 inches (40 mils); securing a substantially transparent solid spacer adjacent the lens sheet; and providing an image adjacent the spacer opposite the lens sheet so as to be spaced a distance from the lens sheet substantially corresponding to the lens focal length.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a cross-sectional side view of a lenticular structure according to an embodiment of the disclosure.

FIG. 2 is a cross-sectional side view of a lenticular structure according to another embodiment of the disclosure.

### DETAILED DESCRIPTION

With reference to the drawings, the disclosure relates to a large format lenticular structure 10 of the type suitable for use in connection with large tradeshow displays, outdoor advertisements, and the like. The lenticular structure 10 has a lens focal length F of greater than about 0.04 inches (40 mils). The lens focal length will be understood to correspond to the distance of focus from a lens and, in the context of a lenticular image structure such as the structure 10, the distance of focus from the lens of a lenticular sheet to the image to be viewed using the lens.

In this regard, the lenticular structure 10 a lenticular sheet 12 having a thickness T₁₂ a first adhesive layer 14 having a thickness T₁₄, a spacer 16 having a thickness T₁₆, and an image 18 having a thickness T₁₈. The lens focal length F is greater than about 0.04 inches (40 mils) and the thickness T₁₂ is about 0.04 inches (40 mils) or less. The thickness T₁₆ of the spacer 16 is selected to substantially provide any additional distance required to position the image 18 a distance from the lenses of the lenticular sheet 12 substantially corresponding to the lens focal length F as described in more detail below. The image 18 is registered with the lenticular sheet 12 to provide a desired visual effect.

The lenticular sheet 12 includes lenses 20 formed on a lens side 22 and an opposite smooth side 24. A suitable lenticular sheet 12 may be provided by extruded lenticular sheets having a thickness (T₁₂) of up to about 0.04 inches (40 mils). While thicker or thinner lenticular sheets may be used, it has been observed that suitable structures may be achieved by the use of conventional lenticular sheets with a thickness of up to about 0.04 inches. The lenticular sheet 12 may be made from a variety of thermoplastic polymeric materials, such as polyvinyl chlorides, acrylic, polyethylene terephthalates, polyesters, polycarbonates, and the like commonly used in the manufacture of lenticular sheets.

The lenticular sheet 12 may have a lens pattern ranging from about 30 to about 60 lenses per inch. However, it will be understood that the lens pattern may be otherwise selected depending on the desired visual effect. Suitable lenticular sheets are conventional extruded polypropylene lenticular sheets available from Spartech Plastics in Sheboygan Falls, Wis. Embossed, cast, and other formed lenticular sheets may also be used. The lenticular material is described herein as being provided in sheet form, however, it will be understood that the lenticular material may also be provided in a web or roll form if desired.

The first adhesive layer 14 is used to adhere a surface 26 of the spacer 16 to the smooth side 24 of the lenticular sheet 12. The adhesive layer 14 is substantially transparent and may be, for example, a double-sided clear adhesive tape, UV activated liquid adhesive, pressure sensitive adhesive, or the like. The adhesive layer 14 typically has a thickness (T₁₄) of from about 0.001 to about 0.003 inches, generally about 0.002 inches.

The spacer 16 functions to space the image 18 apart from the lenses 20 a distance corresponding to the desired focal length. For example, a lenticular sheet having a twenty lenticles per inch (20 lpi) and a narrow viewing angle is observed to have a lens focal length of about 0.25 inches. It has been observed that for such a lenticular sheet, desirable viewing effects may be achieved by locating the printed image 18 about 0.25 inches behind the lenses 20 such that such distance (T₁₂+T₁₄+T₁₆) substantially corresponds to the lens focal length F.

Thus, for a lens focal length F of 0.15 inches utilizing the lenticular sheet 12 having a thickness of 0.04 inches and the adhesive 14 having a thickness of 0.002 inches, the spacer 16 would have a thickness of about 0.108 inches. Likewise, if the lenticular sheet 12 had a lens focal length of 0.25 inches (but with the same thickness), the spacer 16 would have a thickness of 0.208 inches.

The spacer 16 has opposite surfaces 28 and 30, with the surface 28 located adjacent the smooth side 24 of the lenticular sheet. Both the surfaces 28 and 30 are substantially smooth. The image 18 is located adjacent the surface 30 of the spacer 16. The thickness (T₁₆) of the spacer 16 is selected so that the sum of the thickness of the lenticular sheet 12, the adhesive layer 14, and the spacer 16 (e.g., T₁₂+T₁₄+T₁₆) substantially corresponds to the desired focal length for a given lenticular sheet 12. That is, the image 18 is located a distance from the lenses 20, which distance substantially corresponds to the lens focal length of the lenticular sheet 12.

The spacer 16 is a planar substantially rigid solid sheet made of a clear material, or at least substantially transparent material, such as acrylics, PTEG, APET, plexiglass, glass, and the like. The lenticular sheet 12 and the spacer 16 may be clear or tinted.

For example, in one embodiment, the image 18 is printed directly on the surface 30 which is located from the lenses 20 a distance equal to the sum of the thickness of the lenticular sheet 12, the adhesive layer 14, and the spacer 16, which distance substantially corresponds to the focal length F. The spacer 16 also advantageously provides durability desirable to enable outdoor advertisements and the like to withstand weather and temperature extremes.

The image 18 may be a pattern, graphic or other lenticular printed image printed using a suitable ink directly onto the surface 30 of the spacer 16. The printing may be accomplished as by conventional techniques such as lithographic, screen printing, ink jet printing, and the like. Lenticular printing is a well-known multi-step process consisting of creating a lenticular image from at least two existing images, and combining it with a lenticular lens. This process can be used to create various frames of animation (for a motion effect), offsetting the various layers at different increments (for a 3D effect), or simply to show a set of alternate images which may appear to transform into each other. Once the various images are collected, they are flattened into individual, different frame files, and then digitally combined into a single final file in a process called interlacing.

The image 18 may be a single image or graphic or preferably a plurality of images and graphics printed to provide a viewer with a three-dimensional effect or other multi-dimensional effect, such as a motion effect. This may be accomplished as by printing interlaced images, with the lens providing the dimensional effect. The interlaced images may be created as by use of commercially available graphics software, with a computerized printing process. The ink applied to provide the image 30 is preferably applied at a thickness of from about 0.001 to about 0.003 inches. The image 30 may preferably include a small amount of a white or similar colored ink applied to provide a background for the image 30 in the manner of an opaque or flood coating.

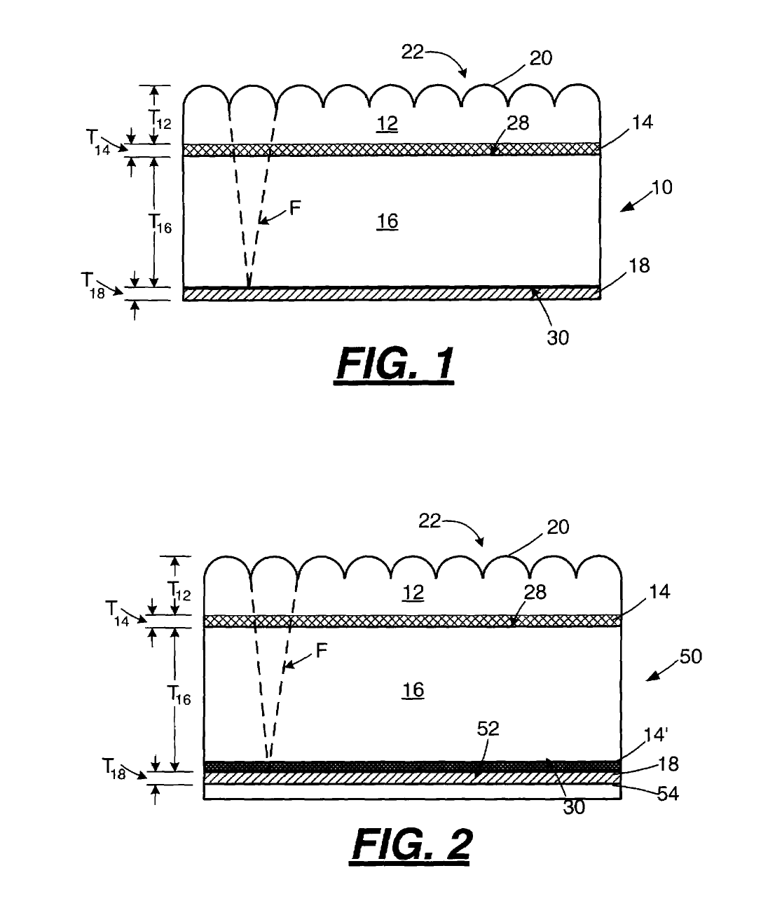

With reference to FIG. 2, there is shown an alternate embodiment of a large format lenticular structure 50. As with the structure 10 described in connection with FIG. 1, the focal length F of the structure 50 is greater than about 0.04 inches (40 mils). The lenticular structure 50 is substantially similar to the structure 10, except that the image 18 is printed on inner surface 52 of a substrate 54 adhered using adhesive 14′ adjacent the surface 30 of the spacer. Thus, the spacer 16 may be slightly thinner than as described in connection with the structure 10, such that the image 18 is located a distance from the lenses 20 corresponding to the focal length F. That is, the thickness of the spacer 16 may be reduced by a thickness of the adhesive 14′. The adhesive 14 may correspond to the adhesive 14 such that the thickness of the adhesive 14′ is generally about 0.002 inches. It has been observed that due to the slight thickness of the adhesive 14′, the spacer 16 may have the same thickness for the structures 10 and 50, and there is no need to reduce the thickness of the spacer by 0.002 inches to provide the structure 50, since the image 18 will still be located a distance from the lenses 20 substantially corresponding to the focal length F.

The substrate 54 may be a film, paper, plastic, glass or like material which suitably receives the image 18 using the conventional lenticular image printing techniques discussed previously.

The foregoing description of preferred embodiments of this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A large format lenticular composite comprising:
a lenticular lens sheet having a thickness of about 0.04 inches (40 mils) or less and including a first surface defining a plurality of lenticular lenses and a second opposite and substantially smooth surface, wherein, the lens sheet has a lens focal length greater than about 0.04 inches (40 mils);
a substantially transparent solid spacer having a thickness defined between first and second opposite surfaces, with the first surface of the spacer being adhesively secured adjacent the second surface of the lens sheet; and
an image located adjacent the second surface of the spacer so as to be spaced a distance from the lenses substantially corresponding to the focal length of the lenticular sheet.

2. The lenticular composite of claim 1, wherein the image is printed onto the second surface of the spacer.

3. The lenticular composite of claim 1, further comprising a substrate having a first substrate surface secured adjacent the second surface of the spacer, and wherein the image is printed onto the first substrate surface.

4. The lenticular composite of claim 1, wherein the substrate has a thickness of at least twice the thickness of the lenticular sheet.

5. A large format lenticular composite, comprising: a lenticular lens sheet having a thickness of about 0.04 inches (40 mils) and a lens focal length greater than about 0.04 inches (40 mils): a substantially transparent solid spacer adjacent the lens sheet; and an image located adjacent the spacer opposite the lens sheet so as to be spaced a distance from the lens sheet substantially corresponding to the lens focal length.

6. A method of making a large format lenticular composite, comprising the steps of:
providing a lenticular lens sheet having a thickness of about 0.04 inches (40 mils) and a lens focal length greater than about 0.04 inches (40 mils);
securing a substantially transparent solid spacer adjacent the lens sheet; and
providing an image adjacent the spacer opposite the lens sheet so as to be spaced a distance from the lens sheet substantially corresponding to the lens focal length.
